(19) United States
(12) Patent Application Publication
(10) Pub. No.: US 2005/0069627 A1
(43) Pub. Date: Mar. 31, 2005

(54) Process for preparation of fructooligosaccharides (FOS)

(76) Inventors: Nagaraja Rao Ramesh Mysore, Mysore (IN); Mahadevaiah Shivakumara, Mysore (IN); Pariyarath Thondre Sangeetha, Mysore (IN); Siddalingaiya Gurudutt Prapulla, Mysore (IN); Maya Prakash, Mysore (IN)

Correspondence Address: Law Office - Dinesh Agarwal, P.C., 5350 Shawnee Road, Suite 330, Alexandria, VA, 22312, US

(21) Appl. No.: 10/809,811

(22) Filed: Mar. 26, 2004

(30) Foreign Application Priority Data
Mar. 27, 2003 (IN) 487DEL2003

(51) Int. Cl. A23G 3/30

(52) U.S. Cl. 426/658

(57) ABSTRACT

The present invention relates to preparation of Fructooligosaccharide (FOS). The FOS in prepared by the reaction of extracellular Fructosyl Transferase (FTase) enzyme obtained from Aspergillus species.

### FIELD OF THE INVENTION

The present invention relates to preparation of Fructooligosaccharide (FOS). The FOS in prepared by the reaction of extracellular Fructosyl Transferase (FTase) enzyme obtained from Aspergillus species.

### BACKGROUND INFORMATION

FOS are oligomers of fructose having degree of polymerization 3-10 with a terminal glucose moiety where the fructose monomers are linked by β2-1 linkage. They are naturally found in vegetables, fruits, cereals and honey. These molecules are obtained by the action of fructosyl transferase on sucrose. They are only about one-third as sweet as sucrose, non-cariogenic, have low calorific value and promote the proliferation of bifidobacteria in the colon. These properties indicate their use as a healthy ingredient of milk products, fruit products, baked foods, beverages, confectionery etc. It will be convenient to use FOS form in all food preparations.

Reference may be made to the preparation of crystal powder of fructooligosaccharide (Kouno Toshiaki et al, JP60149596 dated 07-08-1985) wherein a fructooligosaccharide solution containing >=60 wt % nystose was concentrated into 75-90 wt %, 0.1-10 wt % seed crystal containing crystal nystose was dispersed into the concentration solution and FOS was crystallized, solidified, aged, dried and powdered. The technique used for crystal powder is different from the present process. In addition, the preparation chain includes complicated unit operations like seeding the concentrated solution and additional steps like concentration and aging. Another drawback is that the powder consists of only nystose, one of the oligosaccharide, whereas the present product consists of three oligosaccharides—kestose, nystose and fructofuranosyl nystose. The presence of higher oligosaccharides is advantageous in that it provides the dietary fibre effect.

Reference may be made to a functional food preparate (Kaurala Marita et al, WO9907239 dated 18-O₂-1999) wherein a functional food preparation is made comprising of a vegetal substance containing phytooestrogen, crushed flax seed containing lignan and soya flour containing isoflavonoids and a prebiotic compound like inulin. This process is different from the present one in that the FOS used is based on inulin. The composition is different and is basically a functional food formulation, which is different from our invention. FOS is added in liquid form as one of the ingredients to enhance intestinal activity.

Reference may be made to a process for the preparation of crystalline 1—kestose (U.S. Pat. No. 6,479,657, Dated Nov. 12, 2002, Nishizawa, et al.) wherein granular crystal 1-kestose in the form of large crystals can be produced. A pure solution of 1-kestose is concentrated to a Brix of 75 or more, seed crystals are added, or the solution is vacuum-concentrated to generate microcrystals for use as nuclei. Repeated vacuum-concentration and redissolving microcrystals, which have formed in the concentrate result in crystalline 1—kestose. In another method, a highly pure solution of 1-kestose is concentrated to a Brix of 80 or higher; either seed crystals are added, or the solution is allowed to initiate crystallization. After the crystals are allowed to grow, a cooling step follows where in the temperature is lowered by 5° C. to 20° C. from the previous step. This is followed by a crystal-growing step where the concentrate is maintained at the temperature to allow the crystals to grow. This process is different from the present one in that it results in only crystalline 1—kestose whereas the present process produces a FOS with higher oligosaccharides like nystose. The technique suggested is difficult and complicated whereas the present process is simple.

Reference may be made to a process for the preparation of a low-density fructan (U.S. Pat. No. 6,322,835, dated Nov. 27, 2001, De Soete et al) wherein a low-density fructan is prepared after dispersing the fructan powder in aqueous medium and mixing with maltodextrins, polydextrose, sucrose, poyols and high intensity sweeteners. The draw back of the process is that the fructan powder had to be dissolved in an aqueous medium along with additives like maltodextrin. Another drawback is that an inert gas had to be dispersed into the suspension before it was spray dried to make low-density fructan.

FOS are usually extracted from plants like Chicory and Jerusalem artichoke or prepared by the action of microbial fructosyl transferase (FTase) enzyme on sucrose. Jaggery, a concentrated sugar cane juice with or without purification produced by cottage industries (also known as gur) containing 75-85% sucrose is widely used in India as a substitute for white and refined cane sugar. In the present study, jaggery is used to prepare FOS using FTase from Aspergillus oryzae CFR 202.

There are many reports regarding the improvement of the properties and keeping qualities of jaggery and the preparation of various sweet dishes using jaggery. However, there are only very few reports wherein jaggery has been used as an ingredient in the fermentation media.

References may be made to S. V. N. Vijayendra, D. Bansal, M. S. Prasad and Krishna Nand, Process Biochemistry, 37, 359-364, 2001, wherein jaggery was used as a novel substrate for pullulan production by Aureobasidium pullulans CFR 77. A pullulans CFR 77 was grown in batch fermentation using jaggery as a carbon source. The maximum yield of pullulan was obtained using 5% jaggery in the fernmentation broth in 72 h. The process is different from the present process since it results in the production of a polysaccharide.

Reference may be made to P. Ambati and C. Ayyanna, World Journal of Microbiology and Biotechnology, 17, 331-335, 2001 where in palmyra jaggery was used as carbon source for citric acid production using Aspergillus ngier MTCC 281 by submerged fermentation. Maximum citric acid production was obtained after 136.8 h of fermentation with 221.66 g/L of jaggery in the medium. The process is different from the present one in that the product is an acid. The drawbacks of the process are the longer fermentation time (136.8 h) and high substrate concentration used in the fermentation medium (221.66 g/L).

References may be made to a process for the production of fructooligosaccharides (Prapulla. S. G. Sangeetha, P. T. and Ramesh M. N. 439/Del/2001, March 2001) wherein FOS was prepared using Extracellular fructosyl transferase enzyme obtained by growing Aspergillus oryzae under submerged fermentation conditions. The process is different from the present one in that it used only sucrose as the carbon source in the medium and as substrate for FTase to produce FOS.

Reference may be made to an improved process for the production of fructooligosaccharides (Prapulla. S. G. Sangeetha. P. T and Ramesh M. N, 411/DEL/2001, March 2001) wherein FOS was prepared using FTase obtained from the sonicated culture broth of Aureobasidium pullulans CFR 77. The process is different from the present one in that it uses the sonicated culture broth as source of FTase and it involves additional steps like sonication and centrifugation to obtain the enzyme. Further, it uses only sucrose as the carbon source for the production of FTase and as substrate for the production of FOS.

Fructooligosaccharides are functional food ingredients that have the potential to improve the flavor and physicochemical characteristics of food. They possess properties beneficial to human health, including non-cariogenicity, low calorific value and the ability to stimulate the growth of beneficial bacteria in the colon. Major uses are in beverages, infant milk powders, confectionery, bakery products, yoghurts and dairy desserts. However, the FOS prepared conventionally using microbial enzymes is 40% less sweet than sucrose. This calls for the addition of sugar when FOS is used for the preparation of products. Though this is one of the alternatives, it reduces the health benefits of FOS like non-cariogenicity and low calorific value. Also, there are a few reports pointing towards the application of FOS as an alternative sweetener for diabetic applications. This is possible, as FOS does not invoke insulin metabolism in diabetics. Once, FOS based products are fortified with sucrose, the very purpose of using FOS is defeated. Usage of more quantity of FOS to equalize the sweetness level is not possible due to restriction on the FOS dosage by Recommended Daily Allowance (RDA). In view of this, it is necessary to develop FOS with improved sweetness that is equivalent to sucrose. Hence, a process for the production of FOS with improved sweetness has been developed. The reaction for the production is carried out using stevia extract.

Stevia Rebaudiana is an herb in the Chrysanthemum family, which grows wild as a small shrub. The glycosides in its leaves, including up to 10% stevioside, account for its incredible sweetness, making it unique among the nearly 300 species of stevia plants. It is currently legal as a dietary supplement and must be labeled as such. In September of 1995, the FDA allowed stevia and its extracts as a food supplement but not as a sweetener._Stevia rebaudiana will not participate in the metabolism, accumlate anything or has poisonous effect in the body. FAO and WHO have confirmed its safety. Steviosides and rebaudiosides are the principal constituents of diterpene glucosides with differing sugar molecules attached, as found in the leaves of the stevia plant. Extracted, they are currently being used as sweetening agents in several countries, including Japan, China, Korea, Taiwan, Israel, Uraguay, Brazil, and Paraguay. In Japan, commercialization of stevia was very rapid, beginning with the ban of artificial sweeteners during the 1960's.

While there is no question that stevia is sweet, many users will admit that they have also experienced a bitter aftertaste from some brands. In fact, one of the problems with stevia products currently available from health food retailers is that, many of them are just plain and do not taste good. They often have a distinct grassy taste, with varying degrees of bitterness associated with the sweetness. These differences in quality may be due to poor extraction and processing techniques. Due to FDA regulations, pure stevioside or rebaudioside is not allowed. Even the leaf is suspect if it is labeled as a sweetener. Producers must exercise great caution in their labeling practices to avoid FDA involvement. Stevia and stevia extract are considered foods. Sweeteners are not foods, but food additives. The primary reason that stevia is combined with the other herbs is to enhance the nutritive value of the other herbs. Stevia is nutrient-rich, containing substantial amounts of protein, calcium, phosphorous and other important nutrients.

Reference may be made to a commercial product “Stevia Plus” by Wisdom Herbs (www.wisdomherbs.com) wherein Stevia Plus prepared contains the intensely sweet glycosides (200-400 times sweeter than sugar) extracted from Stevia leaves, and a probiotic nutritional supplement called Frutafit® Inulin Fiber (fructooligosaccharides, also known as FOS). Frutafit® Inulin (FOS), a functional food ingredient, is a mildly sweet, low calorie powder, which is found in chicory, fruits, and vegetables.

The main difference between our product and stevia plus is that, inulin, which is a plant-based fructooligosaccharides has been supplemented to stevia extract to make the product more nutritious and as functional food.

Our product is basically a FOS with stevia and stevia is used to increase the sweetness, retaining all the benefits of FOS.

No other reports are available, wherein enzymatic reactions have been carried out in the presence of stevia, a non-nutritive sweetner.

Reference may be made to the production of 2-keto-L-gulonic acid (2 KGA) using Pseudogluconobacter saccharoketogenes with recycling (Yamaguchi et al, U.S. Pat. No. 5,705,373 dated Jan. 6, 1998) where in the P saccharoketogenes is cultured in the medium containing the substrate for production of 2 KGA, the cells as well as the product are recovered and the cells are inoculated into a new medium for repeating the culture and recovering the product at least once. The system is different in that it is for the production of 2 KGA and not for the enzyme, FTase. The draw back of the process is that the recycling is carried out only once.

Reference may be made to the production of Galalctooligosaccharide (Gal OS) using a recycling cell culture of Sterigmatomyces elviae CBS8119 (Onishi N and Tanaka T. Letters in Applied Microbiology, 1998, 26, 136-139) where in Gal OS producing activity of S. elviae CBS 8119 was maintained at high levels during six cycles of production. The system is different in that it deals with the production of Gal OS in the fermentation medium. Another drawback is that it requires the supplementation of ions like Fe²⁺, Zn²⁺, Cu²⁺ and Thiamine —HCl to the culture medium for promoting Gal OS production, whereas the present process requires only the basal medium for recycling culture.

Reference may be made to a continuous culture of Lactobacillus delbrueckii NRRL B-445 with cell recycling to produce cell mass and low molecular weight substances like lactate (Mattiasson B, Hjkorleifsdottir S and Holst 0. In Enzyme Engineering 10, Ed. Okada H, Tanaka A and Blanch H W. Annals of the New York Academy of Sciences, Volume 613, pp 227-233). The system is different in that it involves the production of lactic acid by reusing the cells filtered from the fermentation broth.

The inventors in table 1, provide a comparison between the present invention and the prior arts.

TABLE 1

| | | | Fermentation | | | | |
|---|---|---|---|---|---|---|---|
| | | End | Time | | Product | Number | |
| Prior art | Organism | product | (Days) | rpm | Category | of stages | Utility |
| Vijayendra | Aureobasidium | Pullan | 3 | 150 | Polysacchride | One | Gelling |
| et. al | pullans | | | | | | agent |
| Ambati | Aspergillus | Citric | 5-8 | 150 | Organic acid | One | Acidulant |
| et..al | niger | acid | | | | | |
| Present | Aspergillus | FOS | 4 | 250 | Extracellular | Two | Speciality |
| Invention | oryzae | | | | enzyme and | | product |
| | | | | | FOS | | with |
| | | | | | | | nutraceutical |
| | | | | | | | property |

### OBJECTS OF THE INVENTION

The main object of the present invention is to provide a process for preparation of Fructooligosaccharide (FOS).

Still another object of the present invention is to provide FOS using jaggery as carbon source.

Another Object of the present invention is to improve the sweetness of the FOS using stevia.

Yet another object of the present invention is to provide FOS using recycling of the cultures.

### SUMMARY OF THE INVENTION

The present invention relates to a process for the production of fructooligosaccharides (FOS). The product in particular is prepared by the reaction of extracellular fructosyl transferase (FTase) enzyme obtained from Aspergillus species.

### BRIEF DESCRIPTION OF THE DRAWINGS

FIG. 1 Preparation of FOS by submerged fermentation.

FIG. 2 Preparation of FOS by solid state fermentation.

FIG. 3 Preparation of FOS with improved sweetness

FIG. 4 Preparation of FOS by recycling culture of Aspergillus species

### DETAILED DESCRIPTION OF THE INVENTION

Accordingly, the main embodiment of the present invention relates to the process for obtaining Fructooligosaccharide (FOS), said process comprising the steps of:
(a) growing the culture in a medium at pH in the range of 5 to 6 and temperature in the range of 25 to 30° C. under stirring condition to obtain an inoculum,
(b) transferring predetermined concentration of the inoculum to a medium under fermentation conditions to obtain Fructosyl Transferase (Ftase),
(c) incubating the Ftase with a substrate in the range of 400 to 800 g/l at pH in the range of 5 to 5.5 for 18 to 24 hrs at a temperature range of 50 to 55° C., and
(d) optionally along with additives to improve quality of FOS.

Another embodiment of the present invention relates to the step (a) wherein the medium consists of sucrose in the range of 0.8 to 1.5% and yeast extract in the range of 0.1 to 0.5%.

Yet another embodiment of the present invention relates to the stirring in step (a) which is done at 200 to 250 rpm for 24 to 48 hr.

Still another embodiment of the present invention relates top the the culture used in step (a) which is selected from group consisting of Aspergillus oryzae and Aspergillus pullulans, capable of producing FTase.

One more embodiment of the present invention relates to the inoculum wherein the inoculum used is developed from 5 to 8 days old slant culture.

Another embodiment of the present invention relates to the FTase wherein the Ftase is prepared by fermentation process selected from the group consisting of submerged fermentation process and solid state submerged process.

Still another embodiment of the present invention relates to the the predetermined concentration inoculum wherein the predetermined concentration of the inoculum varies in the range of 10 to 25% (v/v) for submerged fermentation and in the range of 10 to 25% (v/w) for solid state fermentation.

Yet another embodiment of the present invention relates to the submerged fermentation medium wherein the submerged fermentation medium consists of sucrose in the range of 10-12%, yeast extract in the range of 0.7-0.9%, MgSO₄.7H₂O in the range of 0.02-0.04%, NaNO₃ in the range of 1-3%, K₂HPO₄ in the range of 0.3-0.5%, K₂HPO₄ in the range of 0.8-1.0%, NaCl in the range of 0.5-0.7% and NH₄Cl in the range of 0.9-1.2% and incubated for 48 to 120 hr at a temperature ranging from 25-30° C. followed by discarding the pellets after filtering the culture broth to obtain Fructosyl Transferase (Ftase).

One more embodiment of the present invention relates to the solid state fermentation medium wherein the solid state medium consists of 10 to 12 gm of rice bran moistened with 10 to 12 ml water and incubated for 48 to 120 hr at a temperature ranging from 25-30° C. followed by extraction of moldy bran with water and filtering the same to obtain Fructosyl Transferase (Ftase).

Another embodiment of the present invention relates to the FTase wherein FTase is incubated with the substrate selected from group consisting of sucrose, jaggery optionally along with stevia extract as an additive to improve the FOS sweetness.

Yet another embodiment of the present invention relates to the stevia extract wherein the stevia extract is in the range of about 0.5 to 4%.

One more embodiment of the present invention relates to the stevia extract wherein the stevia extract is about 1% Yet another embodiment of the present invention relates to the increase in sweetness of FOS wherein increase in sweetness of FOS is about 40%.

Yet another embodiment of the present invention relates to the increase in sweetness of FOS wherein increase in sweetness of FOS is about 36%.

Yet another embodiment of the present invention relates to FOS wherein the FOS contains kestose and nystose with functional properties namely non-cariogenicity and prebiotic property.

Still another embodiment of the present invention relates to FOS wherein the FOS improves mineral absorption, reduces the total cholesterol and triglyceride levels in the body.

One more embodiment of the present invention relates to FOS wherein 2.5 to 20% of FOS in diet improves the calcium absorption.

One more embodiment of the present invention relates to the FOS wherein 5 to 10% of FOS in diet improves the magnesium absorption.

Another embodiment of the present invention relates to FOS wherein up to 10% of FOS in diet improves the copper absorption.

One more embodiment of the present invention relates to the FOS wherein 8 gm of FOS powder dose per day for weeks in the range of 5 to 5 reduces the cholesterol and triglycerides levels.

Still another embodiment of the present invention relates to the FOS powder wherein the FOS powder is obtained by spray drying of FOS at an inlet temperature ranging from 130 to 140° C., outlet temperature ranging from 90 to 95° C. and at a flow rate of 60 to 70 ml/min.

Yet embodiment of the present invention relates to FOS additives wherein FOS additives are selected from the group consisting of maltodextrin ranging up to 15% and anti-caking agents namely tri-calcium phosphate ranging up to 2% during either before or after spray drying.

Another embodiment of the present invention relates to the FOS powder wherein the FOS powder has dry matter content in the range of 98.6 to 98.8%, ash content in the range of 0.4 to 1.0% with solubility in the range of 95 to 96% in cold water and 100% in hot water.

One more embodiment of the present invention relates to additives wherein the additives improve the storage stability of the FOS powder and reduces the heat sensitively of FOS powder.

Another embodiment of the present invention relates to the yield of FOS powder wherein the yield of FOS powder varies in the range of 50 to 96.5%.

Yet another embodiment of the present invention relates to the culture wherein the culture is recycled for production of FOS.

Still another embodiment of the present invention relates to the culture wherein the culture is recycled at least 6 times for production of FOS.

The following examples are given by way of illustration of the present invention and therefore should not be constructed to limit the scope of the present invention.

### EXAMPLES

### Example 1

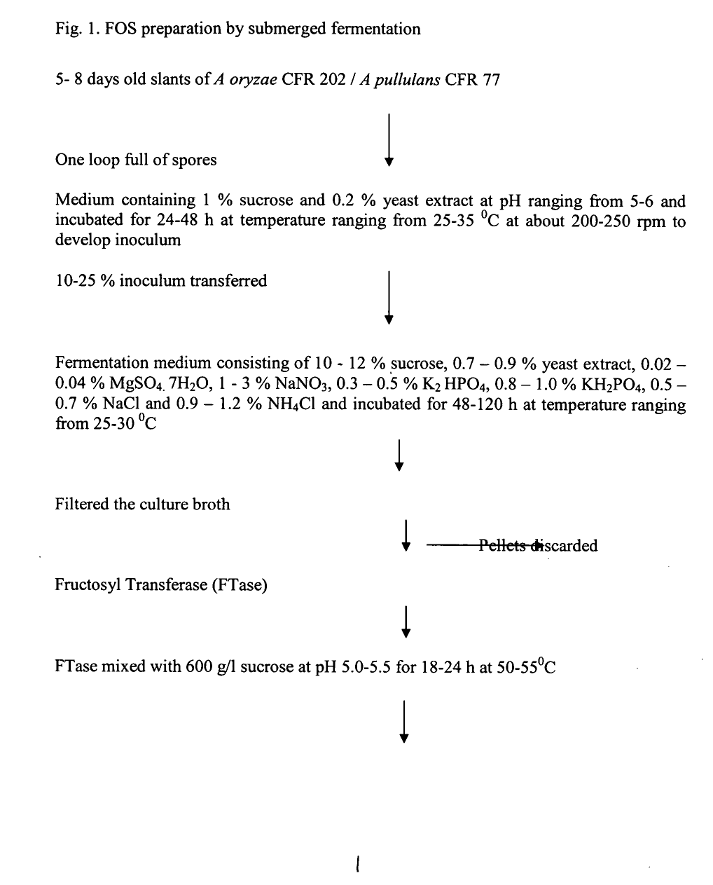

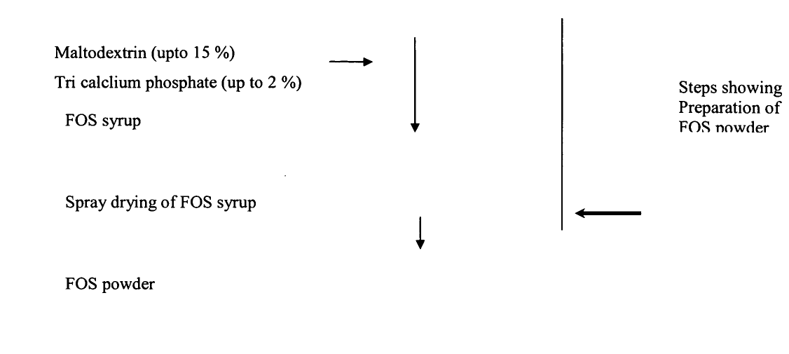

Aspergillus oryzae was grown in 50 ml medium consisting of 1% sucrose and 0.2% yeast extract (pH 5.5) at 30±1° C. for 24 h at 250 rpm to develop inoculum. 20% v/v of the inoculum was transferred to 50 ml fermentation medium in a 250 ml conical flask containing 10% sucrose, 0.8% yeast extract, 0.03% MgSO4, 7H₂O, 2% NaNO3, 0.4% K2 HPO4, 0.9% KH2PO4, 0.6% NaCl and 1% NH4Cl and incubated at 250 rpm for 90 h at 30±1° C. The pellets were separated from the culture fluid by filtration using filter paper (Whatman No.2). The culture fluid obtained was used as the source of extracellular enzyme for the production of FOS. 0.25 ml of the culture fluid was mixed with 1.75 ml of the substrate (600 g/L jaggery) and incubated for 18 h at 55° C. at pH 5.15. The reaction products were analyzed by HPLC using refractive index detector. The maximum FOS yield obtained was 41.98% of the initial sucrose which consisted of 32.07% Kestose and 9.91% Nystose (Table 1; FIG. 1).

### Example 2

Aspergillus oryzae was grown in 50 ml medium consisting of 1% sucrose and 0.2% yeast extract (pH 5.5) at 30±1° C. for 24 h at 250 rpm to develop inoculum. 20% v/v of the inoculum was transferred to 50 ml fermentation medium in a 250 ml conical flask containing 10% extra jaggery, 0.08% yeast extract, 0.03% MgSO4, 7H₂O, 2% NaNO3, 0.4% K2 HPO4, 0.9% KH2PO4, 0.6% NaCl and 1% NH4Cl and incubated at 250 rpm for 90 h at 30±1° C. The pellets were separated from the culture fluid by filtration using filter paper (Whatman No.2). The culture fluid obtained was used as the source of extracellular enzyme for the production of FOS. 0.25 ml of the cultu4re fluid was mixed with 1.75 ml of the substrate (600 g/L jaggery) and incubated for 18 h at 55° C. at pH 5.15. The reaction was stopped by keeping the reaction mixture in boiling water bath. The reaction products were analyzed by HPLC using refractive index detector. The maximum FOS yield obtained was 40.03% of the initial sucrose which consisted of 32.75% Kestose and 7.28% Nystose (Table 1; FIG. 1).

### Example 3

Aspergillus oryzae was grown in 50 ml medium consisting of 1% sucrose and 0.2% yeast extract (pH 5.5) at 30±1° C. for 24 h at 250 rpm to develop inoculum. 20% v/v of the inoculum was transferred to 50 ml fermentation medium in a 250 ml conical flask containing 10% jaggery, 0.8% yeast extract, 0.03% MgSO4, 7H₂O, 2% NaNO3, 0.4% K2 HPO4, 0.9% KH2PO4, 0.6% NaCl and 1% NH4Cl and incubated at 250 rpm for 90 h at 30±1° C. The pellets were separated from the culture fluid by filtration using filter paper (Whatman No.2). The culture fluid obtained was used as the source of extracellular enzyme for the production of FOS. 0.25 ml of the culture fluid was mixed with 1.75 ml of the substrate (600 g/L jaggery) and incubated for 18 h at 55° C. at pH 5.15. The reaction was stopped by keeping the reaction mixture in boiling water bath. The reaction products were analyzed by HPLC using refractive index detector. The maximum FOS yield obtained was 58% of the initial sucrose which consisted of 32.62% Kestose, 22.47% Nystose and 3.06% Fructofuranosyl nystose (Table 2; FIG. 1).

TABLE 2

| Serial No. | Carbon source in the media | Substrate | % of FOS |
|---|---|---|---|
| 1 | Sucrose | Jaggery | 41.98 |
| 2 | Jaggery | Jaggery | 40.03 |
| 3 | Jaggery | Sucrose | 48.59 |
| 4 | Sucrose | Sucrose | 58.00 |

### Example—4

Aspergillus oryzae CFR 202 was grown in 3 L medium consisting of 1% sucrose and 0.2% yeast extract (pH 5.5) at 30±1° C. for 24 h at 250 rpm to develop inoculum. 20% v/v of the inoculum was transferred to 12 L fermentation medium in a 15 L fermentor containing 10% sucrose, 0.8% yeast extract, 0.03% MgSO₄. 7H₂O, 2% NaNO₃, 0.4% K₂ HPO₄, 0.9% KH2PO4, 0.6% NaCl and 1% NH₄Cl under agitation of 150-200 rpm for 96 h at 30±1° C. The mycelia was separated from the culture fluid by filtration and centrifugation. The culture fluid obtained was used as the source of extracellular enzyme for the production of FOS. 1 L of the culture fluid was mixed with 9 L of the substrate (600 g/L sucrose) and incubated for 18 h at 55° C. The reaction was stopped by increasing the temperature of the reaction mixture to 80° C. for 15 minutes. The FOS syrup with 56° brix was spray dried at 130° C. to get FOS powder. 30 mg of the FOS powder was dissolved in 1 ml water and analyzed by HPLC. The powder consisted of 50.8% kestose and 27.1% nystose and 1.67% fructofurnaosyl nystose on w/w basis (Tables 3 and 4).

### Example—5

Aureobasidium pullulans CFR 77 was grown in 3 L medium consisting of 1% sucrose and 0.2% yeast extract (pH 5.5) at 30±1° C. for 24 h at 250 rpm to develop inoculum. 20% v/v of the inoculum was transferred to 12 L fermentation medium in a 15 L fermentor containing 10% sucrose, 0.8% yeast extract, 0.03% MgSO₄. 7H₂O, 2% NaNO₃, 0.4% K₂ HPO₄, 0.9% KH₂PO₄, 0.6% NaCl and 1% NH₄Cl under agitation of 150-200 rpm for 96 h at 30±1° C. The cells were separated from the culture fluid by centrifugation. The culture fluid obtained was used as the source of extracellular enzyme for the production of FOS. 1 L of the culture fluid was mixed with 9 L of the substrate (600 g/L sucrose) and incubated for 18 h at 55° C. The reaction was stopped by increasing the temperature of the reaction mixture to 80° C. for 15 minutes. The FOS syrup with 56° brix was then mixed with 10% Maltodextrin DE-14. The syrup with 60° brix was then spray dried at 130° C. to get FOS powder. 11 mg of the FOS powder was dissolved in 1 ml water and analyzed by HPLC. The powder consisted of 57.9% kestose and 5% nystose on w/w basis (Tables 3 and 4; FIG. 1).

### Example—6

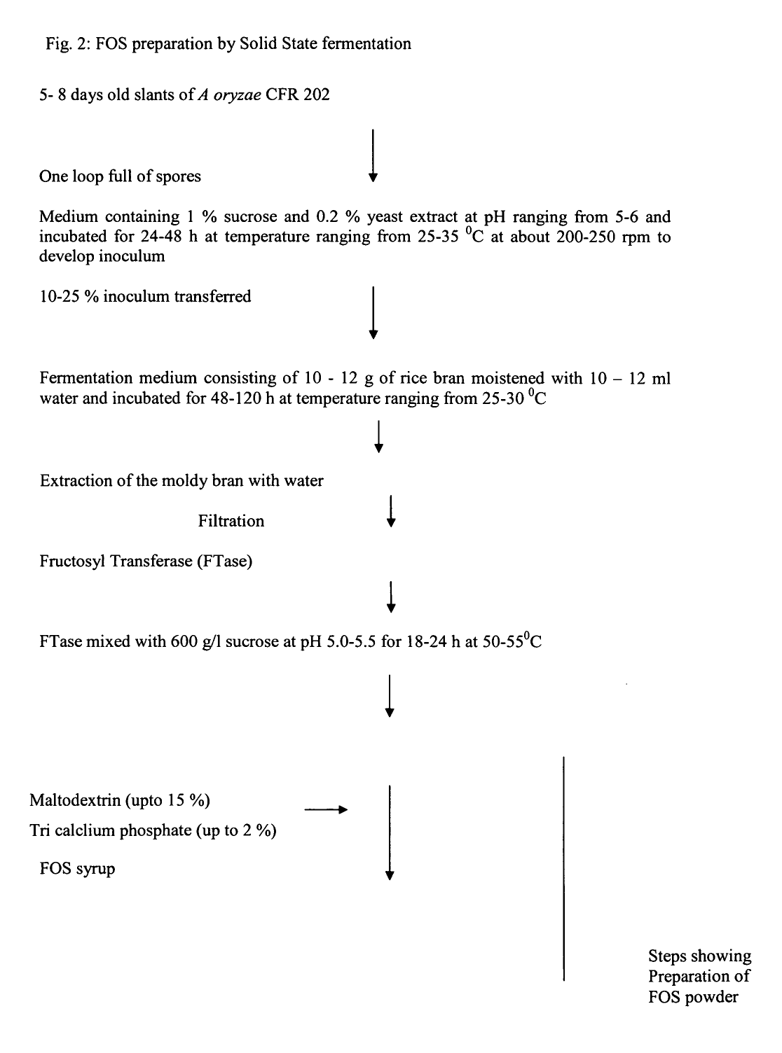

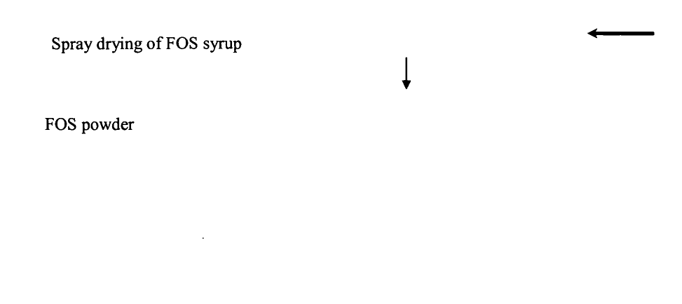

Aspergillus oryzae CFR 202 was grown in 100 ml medium consisting of 1% sucrose and 0.2% yeast extract (pH 5.5) at 30±1° C. for 24 h at 250 rpm to develop inoculum. 20% v/w of the inoculum was transferred to 10 g rice bran moistened with 10 ml water in 250 ml conical flasks for 96 h at 30±1° C. The moldy bran was extracted with water by agitation at 250 rpm for 90 min. The extract was filtered and the filtrate obtained was used as the source of extracellular enzyme for the production of FOS. 1 L of the culture fluid was mixed with 9 L of the substrate (600 g/L sucrose) and incubated for 18 h at 55° C. The reaction was stopped by increasing the temperature of the reaction mixture to 80° C. for 15 minutes. The FOS syrup with 56° brix was then mixed with 2% Tricalcium phosphate. The syrup with 520 brix was then spray dried at 130° C. to get FOS powder. 11 mg of the FOS powder was dissolved in 1 ml of water and analyzed by HPLC. The powder consisted of 82.7% kestose and 13.7% nystose on w/w basis (Tables 3 and 4; FIG. 2).

### Example—7

Aspergillus oryzae CFR 202 was grown in 3 L medium consisting of 1% sucrose and 0.2% yeast extract (pH 5.5) at 30±1° C. for 24 h at 250 rpm to develop inoculum. 20% v/v of the inoculum was transferred to 12 L fermentation medium in a 15 L fermentor containing 10% sucrose, 0.8% yeast extract, 0.03% MgSO₄. 7H₂O, 2% NaNO₃, 0.4% K₂ HPO₄, 0.9% KH₂PO₄, 0.6% NaCl and 1% NH₄Cl under agitation of 150-200 rpm for 96 h at 30±1° C. The mycelia was separated from the culture fluid by filtration and centrifugation. The culture fluid obtained was used as the source of extracellular enzyme for the production of FOS. 1 L of the culture fluid was mixed with 9 L of the substrate (600 g/L sucrose) and incubated for 18 h at 55° C. The reaction was stopped by increasing the temperature of the reaction mixture to 80° C. for 15 minutes. The FOS syrup with 56° brix was then mixed with 10% Maltodextrin DE-14 and 1% tri calcium phosphate. The syrup with 580 brix was then spray dried at 130° C. to get FOS powder. 11 mg of the FOS powder was dissolved in 1 ml of water and analyzed by HPLC. The powder consisted of 46.9% kestose and 4% nystose on w/w basis (Table 3 and 4; FIG. 1).

TABLE 3

| | | Fermentation | | |
|---|---|---|---|---|
| Ex. | Organism | method | Additive used | % FOS |
| 1 | A oryzae | Submerged | — | 78.77 |
| 2 | A pullulans | Submerged | 10% Maltodextrin | 62.9 |
| 3 | A oryzae | Solid state | 2% Tricalcium phosphate | 96.4 |
| 4 | A oryzae | Submerged | 10% Maltodextrin and | 50.9 |
| | | | 2% tricalcium phosphate | |

TABLE 4
Characteristics of FOS powder

| Characteristics | |
|---|---|
| Appearance | Creamish powder |
| Dry matter (%) | 98.6-98.8 |
| Solubility (%) | |
| Cold | 95-96 |
| Hot | 100 |
| Ash (%) | 0.4-1 |
| Bacterial count | Nil |

### Example—8

Aspergillus oryzae CFR 202 was grown in 100 ml medium consisting of 1% sucrose and 0.2% yeast extract (pH 5.5) at 30±1° C. for 24 h at 250 rpm to develop inoculum. 20% v/v of the inoculum was transferred to 100 ml fermentation medium in a 500 ml conical flask containing 10% sucrose, 0.8% yeast extract, 0.03% MgSO₄. 7H₂O, 2% NaNO₃, 0.4% K₂ HPO₄, 0.9% KH₂PO₄, 0.6% NaCl and 1% NH₄Cl and incubated at 250 rpm for 90 h at 30±1° C. The pellets were separated from the culture fluid by filtration using filter paper (Whatman No. 2). The culture fluid obtained was used as the source of extracellular enzyme for the production of FOS. 5 ml of the culture fluid was mixed with 95 ml of the substrate (600 g/L sucrose) prepared in demineralised water incubated for 18 h at 55° C. at pH 5.5. The reaction was stopped by keeping the reaction mixture in boiling water bath. The product was analyzed sensorially to determine the threshold value. The threshold value was 3.6 g % in comparison with 0.4 g % of sucrose equivalent threshold. The quantity of FOS was analysed by HPLC using standard protocols and was found to be 23.4 g in 100 ml (Table 5).

### Example—9

Aspergillus oryzae CFR 202 was grown in 100 ml medium consisting of 1% sucrose and 0.2% yeast extract (pH 5.5) at 30±1° C. for 24 h at 250 rpm to develop inoculum. 20% v/v of the inoculum was transferred to 100 ml fermentation medium in a 500 ml conical flask containing 10% sucrose, 0.8% yeast extract, 0.03% MgSO₄. 7H₂O, 2% NaNO₃, 0.4% K₂ HPO₄, 0.9% KH₂PO₄, 0.6% NaCl and 1% NH₄Cl and incubated at 250 rpm for 90 h at 30±1° C. The pellets were separated from the culture fluid by filtration using filter paper (Whatman No. 2). The culture fluid obtained was used as the source of extracellular enzyme for the production of FOS. 5.0 ml of the culture fluid was mixed with 95 ml of the substrate (600 g/L sucrose) prepared in 1 g % stevia extract, incubated for 18 h at 55° C. at pH 5.5. The reaction was stopped by keeping the reaction mixture in boiling water bath. The product was analyzed sensoriclly to determine the threshold value. The threshold value was 2.3 g % in comparison with 0.4 g % of sucrose equivalent threshold. The quantity of FOS was analysed by HPLC using standard protocols and was found to be 23.4 g in 100 ml (Table 3; FIG. 1).

### Example—10

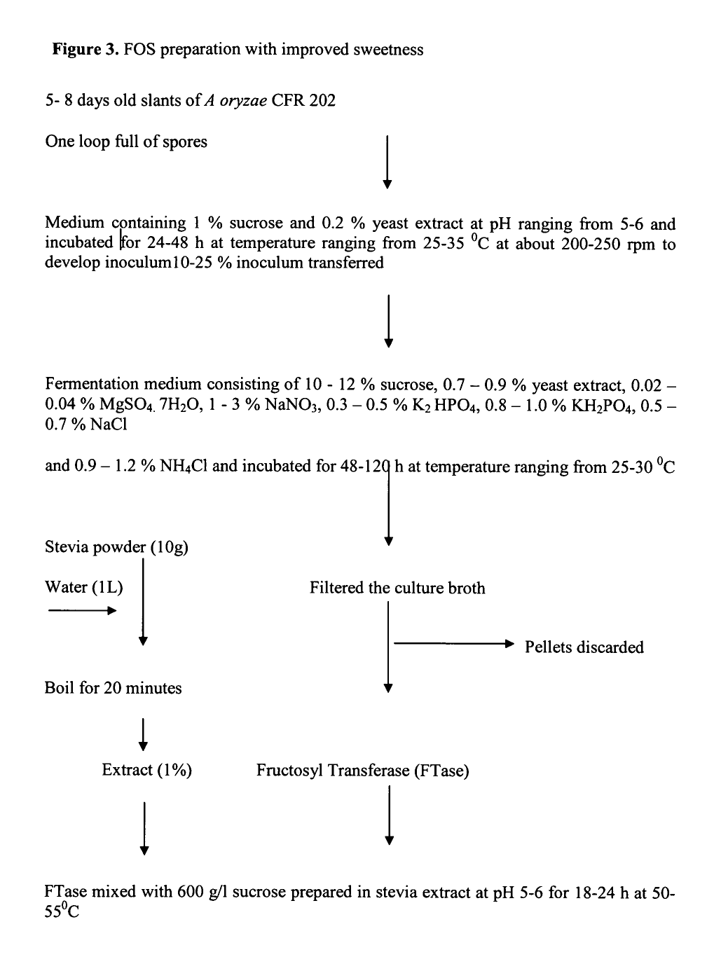

Aspergillus oryzae CFR 202 was grown in 100 ml medium consisting of 1% sucrose and 0.2% yeast extract (pH 5.5) at 30±1° C. for 24 h at 250 rpm to develop inoculum. 20% v/v of the inoculum was transferred to 100 ml fermentation medium in a 500 ml conical flask containing 10% sucrose, 0.8% yeast extract, 0.03% MgSO₄. 7H₂O, 2% NaNO₃, 0.4% K₂ HPO₄, 0.9% KH₂PO₄, 0.6% NaCl and 1% NH₄Cl and incubated at 250 rpm for 90 h at 30±1° C. The pellets were separated from the culture fluid by filtration using filter paper (Whatman No. 2). The culture fluid obtained was used as the source of extracellular enzyme for the production of FOS. 5 ml of the culture fluid was mixed with 95 ml of the substrate (600 g/L sucrose) prepared in demineralised water incubated for 18 h at 55° C. at pH 5.5. The reaction was stopped by keeping the reaction mixture in boiling water bath. About 62 ml of 1 g % stevia extract (quantity used to prepare the substrate in Example 2) was added to 38 mL FOS to obtain 100 mL of the mixture. The product was analyzed sensorially to determine the threshold value. The threshold value was 2.5 g % in comparison with 0.4 g % of sucrose equivalent threshold. The quantity of FOS was analysed by HPLC using standard protocols and was found to be 8.9 g in 100 ml (Table 5; FIG. 3). The FOS content in the control will be more (Table 5; 23.4 g/100 ml) compared to the one where stevia extraxt is added after the reaction (Example Table 5; 8.9 g/100 ml.) With the addition of a known quantity of stevia extract to the a known volume of FOS will result in dillution and hence the FOS content comes dowmn. In this where the reaction is carried in the presence of stevia extract the FOS content remains same (23.4 g/100 ml). Threshold is the minimum quantity required for the perception of the sweetness. Higher the threshold lower the sweetness and lower the threshold higher the sweetness. The Coventional method has higher threshold 3.6% (Table 5) and hence less sweetness, whereas the present invention indicates lower threshold of 2-2.3 g % (Table 5) and higher sweetness. Therefore the table 5 shows that when threshold is lower but the FOS content comes down due to the dilution effect and hence carrying out the reaction in the presence of stevia extract to get a product with higher sweetness is claimed and that is the novelty of the invention. Higher the threshold lower the sweetness, and lower the threshold higher the sweetness.

TABLE 5

| | | Sweetness Threshold | FOS content |
|---|---|---|---|
| Example | Addition of stevia | (g %) | (g/100 mL) |
| 1 | Not added | 3.6 | 23.4 |
| | (Conventional) | | |
| 2 | During reaction | 2.3 | 23.4 |
| 3 | After reaction | 2.5 | 8.9 |

### Example—11

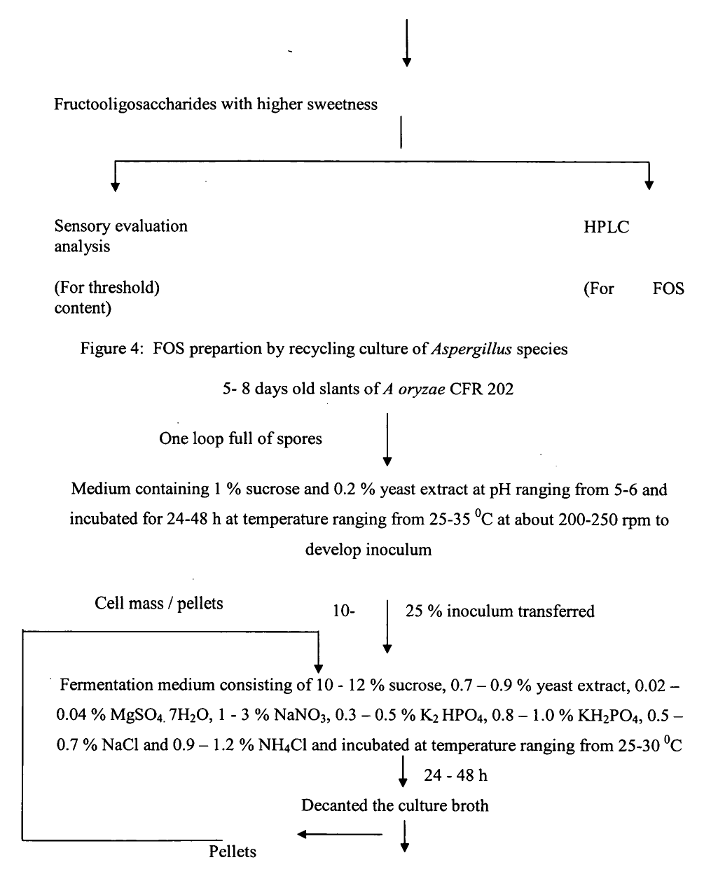

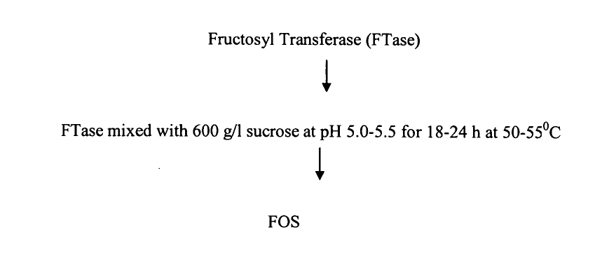

Aspergillus oryzae CFR 202 was grown in 100 ml medium consisting of 1% sucrose and 0.2% yeast extract (pH 5.5) at 30±1° C. for 24 h at 250 rpm to develop inoculum. 20% v/v of the inoculum was transferred to 100 ml fermentation medium in a 500 ml conical flask containing 10% sucrose, 0.8% yeast extract, 0.03% MgSO₄.7H₂O, 2% NaNO₃, 0.4% K₂ HPO₄, 0.9% KH₂PO₄, 0.6% NaCl and 1% NH₄Cl under agitation of 150-200 rpm for 120 h at 30±1° C. An aliquot of the culture fluid was taken after 48, 72, 96 and 120 h by decanting the broth. The culture fluid obtained was used as the source of extracellular FTase for the production of FOS. 0.25 ml of the culture fluid was mixed with 0.75 ml of the substrate (600 g/L sucrose) and incubated for 1 h at 55° C. at pH 5-5.5 to determine the FTase activity and for 18 h under the same conditions to obtain FOS. The reaction was stopped by keeping the tubes in boiling water bath for 15 min. FTase activity was calculated based on glucose released after 1 h reaction. Glucose released was estimated using GOD-POD kit. FTase activity was 6.91, 7.27, 9.37 and 10.87 U/ml/min after 48, 72, 96 and 120 h respectively. FOS obtained was analyzed by HPLC. The concentration of FOS was 48.92, 51.11, 55.40 and 54.86% after 48, 72, 96 and 120 h respectively (Table 6; FIG. 4).

### Example—12

Aspergillus oryzae CFR 202 was grown in 100 ml medium consisting of 1% sucrose and 0.2% yeast extract (pH 5.5) at 30±1° C. for 24 h at 250 rpm to develop inoculum. 20% v/v of the inoculum was transferred to 100 ml fermentation medium in a 500 ml conical flask containing 10% sucrose, 0.8% yeast extract, 0.03% MgSO₄. 7H₂O, 2% NaNO₃, 0.4% K₂ HPO₄, 0.9% KH₂PO₄, 0.6% NaCl and 1% NH₄Cl under agitation of 150-200 rpm for 48 h at 30±1° C. The pellets were separated from the culture fluid by decanting the broth. The culture fluid obtained was used as the source of extracellular enzyme for the production of FOS. 0.25 ml of the culture fluid was mixed with 0.75 ml of the substrate (600 g/L sucrose) and incubated for 1 h at 55° C. at pH 5-5.5 to estimate the FTase activity and for 18 h under the same conditions to obtain FOS. The reaction was stopped by keeping the tubes in boiling water bath for 15 min. FTase activity was calculated based on glucose released after 1 h reaction. Glucose released was estimated using GOD-POD kit. FTase activity was 7.9 U/ml/min. FOS obtained was analyzed by HPLC. The concentration of FOS was found to be 48.9%.

### Example—13

100 ml fermentation medium containing 10% sucrose, 0.8% yeast extract, 0.03% MgSO₄.7H₂O, 2% NaNO₃, 0.4% K₂ HPO₄, 0.9% KH₂PO₄, 0.6% NaCl and 1% NH₄Cl was added to.

Aspergillus oryzae CFR 202 pellets obtained from example 1. The flasks were incubated for 24 h under agitation of 150-200 rpm at 30±1° C. The pellets were separated from the culture fluid by decanting the broth. The culture fluid obtained was used as the source of extracellular enzyme for the production of FOS. 0.25 ml of the culture fluid was mixed with 0.75 ml of the substrate (600 g/L sucrose) and incubated for 1 h at 55° C. at pH 5-5.5 to estimate the FTase activity and for 18 h under the same conditions to obtain FOS. The reaction was stopped by keeping the tubes in boiling water bath for 15 min. FTase activity was calculated based on glucose released after 1 h reaction. Glucose released was estimated using GOD-POD kit. FTase activity was 14.52 U/ml/min. FOS obtained was analyzed by HPLC. The concentration of FOS was found to be 52.8%.

### Example—14

100 ml fermentation medium containing 10% sucrose, 0.8% yeast extract, 0.03% MgSO₄ 7H₂O, 2% NaNO₃, 0.4% K₂ HPO₄, 0.9% KH₂PO₄, 0.6% NaCl and 1% NH₄Cl was added to.

Aspergillus oryzae CFR 202 pellets obtained from example 2. The flasks were incubated for 24 h under agitation of 150-200 rpm at 30±1° C. The pellets were separated from the culture fluid by decanting the broth. The culture fluid obtained was used as the source of extracellular enzyme for the production of FOS. 0.25 ml of the culture fluid was mixed with 0.75 ml of the substrate (600 g/L sucrose) and incubated for 1 h at 55° C. at pH 5-5.5 to estimate the FTase activity and for 18 h under the same conditions to obtain FOS. The reaction was stopped by keeping the tubes in boiling water bath for 15 min. FTase activity was calculated based on glucose released after 1 h reaction. Glucose released was estimated using GOD-POD kit. FTase activity was 16.68 U/ml/min. FOS obtained was analyzed by HPLC. The concentration of FOS was found to be 52.7%.

### Example—15

100 ml fermentation medium containing 10% sucrose, 0.8% yeast extract, 0.03% MgSO₄.7H₂O, 2% NaNO₃, 0.4% K₂ HPO₄, 0.9% KH₂PO₄, 0.6% NaCl and 1% NH₄Cl was added to.

Aspergillus oryzae CFR 202 pellets obtained from example 3. The flasks were incubated for 24 h under agitation of 150-200 rpm at 30±1° C. The pellets were separated from the culture fluid by decanting the broth. The culture fluid obtained was used as the source of extracellular enzyme for the production of FOS. 0.25 ml of the culture fluid was mixed with 0.75 ml of the substrate (600 g/L sucrose) and incubated for 1 h at 55° C. at pH 5-5.5 to estimate the FTase activity and for 18 h under the same conditions to obtain FOS. The reaction was stopped by keeping the tubes in boiling water bath for 15 min. FTase activity was calculated based on glucose released after 1 h reaction. Glucose released was estimated using GOD-POD kit. FTase activity was 12.58 U/ml/min. FOS obtained was analyzed by HPLC. The concentration of FOS was found to be 53.4%.

### Example—16

100 ml fermentation medium containing 10% sucrose, 0.8% yeast extract, 0.03% MgSO₄.7H₂O, 2% NaNO₃, 0.4% K₂ HPO₄, 0.9% KH₂PO₄, 0.6% NaCl and 1% NH₄Cl was added to.

Aspergillus oryzae CFR 202 pellets obtained from example 4. The flasks were incubated for 24 h under agitation of 150-200 rpm at 30±1° C. The pellets were separated from the culture fluid by decanting the broth. The culture fluid obtained was used as the source of extracellular enzyme for the production of FOS. 0.25 ml of the culture fluid was mixed with 0.75 ml of the substrate (600 g/L sucrose) and incubated for 1 h at 55° C. at pH 5-5.5 to estimate the FTase activity and for 18 h under the same conditions to obtain FOS. The reaction was stopped by keeping the tubes in boiling water bath for 15 min. FTase activity was calculated based on glucose released after 1 h reaction. Glucose released was estimated using GOD-POD kit. FTase activity was 11.35 U/ml/min. FOS obtained was analyzed by HPLC. The concentration of FOS was found to be 53.14%.

### Example—17

100 ml fermentation medium containing 10% sucrose, 0.8% yeast extract, 0.03% MgSO₄. 7H₂O, 2% NaNO₃, 0.4% K₂ HPO₄, 0.9% KH₂PO₄, 0.6% NaCl and 1% NH₄Cl was added to.

Aspergillus oryzae CFR 202 pellets obtained from example 5. The flasks were incubated for 24 h under agitation of 150-200 rpm at 30±1° C. The pellets were separated from the culture fluid by decanting the broth. The culture fluid obtained was used as the source of extracellular enzyme for the production of FOS. 0.25 ml of the culture fluid was mixed with 0.75 ml of the substrate (600 g/L sucrose) and incubated for 1 h at 55° C. at pH 5-5.5 to estimate the FTase activity and for 18 h under the same conditions to obtain FOS. The reaction was stopped by keeping the tubes in boiling water bath for 15 min. FTase activity was calculated based on glucose released after 1 h reaction. Glucose released was estimated using GOD-POD kit. FTase activity was 11.5 U/ml/min. FOS obtained was analyzed by HPLC. The concentration of FOS was found to be 52.62%.

TABLE 6
Comparative results of FOS obtained by conventional Submerged
Fermentation and recycling cell culture of A oryzae CFR 202

| Fermentation time in h | FOS (%) | FOS (%) |
|---|---|---|
| (Cycle no.) | With recycling | Without recycling |
| 48 (1) | 48.90 | 48.92 |
| 72 (2) | 52.80 | 51.11 |
| 96 (3) | 52.70 | 55.40 |
| 120 (4) | 53.40 | 54.86 |
| 144 (5) | 53.14 | 40.03 |
| 168 (6) | 52.62 | 39.58 |

The advantages of the present invention are:
1. The FOS powder is prepared by the reaction of microbial FTase with sucrose.
2. The FOS powder consists of kestose and nystose in higher concentrations up to 96% (w/w).
3. The FOS powder has prebiotic properties characteristic of kestose and nystose.
4. The process is simple and involves spray drying of the syrup, which is a conventional method of getting powder.
5. The product has low levels of reducing sugars which will give it low calorific value
6. The FOS powder is stable at room temperature after mixing it with any anticaking agent like tri calcium phosphate and storing in aluminum packages.
7. FTase obtained by growing A oryzae CFR 202 on a cheaper carbon source like jaggery.
8. FOS can be obtained using jaggery/sucrose as substrate at a concentration of 600 g/L/.
9. A minimum of 90 h of fermentation is only needed to produce higher titers of fructosyl transferase.
10. The product obtained is sweeter than FOS prepared conventionally with only sucrose as substrate
11. The product obtained is also sweeter than that of the mixture of conventional FOS and stevia extract (added after the reaction).
12. The increase in sweetness is 36% as compared to the FOS prepared by conventional method.
13. The increase in sweetness is 8% as compared to the mixture of FOS prepared by conventional method and stevia extract.
14. The sweetness of FOS prepared by the present method can be increased by increasing the concentration of the stevia extract from 1 to 5%.
15. The increase in FOS content for 100 ml of the reaction mixture in the presence of stevia is 2.5 times than adding the stevia extract and the FOS after the reaction.
16. This system allows repeated use of A oryzae CFR 202 pellets for FTase production six times.
17. FTase produced after recycling culture can be used for repeated production of FOS.
18. The process does not require supplementation of any additional nutrients for recycling culture.
19. The inoculum developed once can be used six times avoiding the step of fresh inoculum development.
20. The fermentation time for the subsequent cycles reduces considerably from 96 to 24 h.
21. By recycling, 100 ml FTase is obtained after every cycle with a total volume of 600 ml FTase at the end of 6th cycle whereas without recycling only 100 ml FTase is obtained at the end of 120 h of fermentation.
22. The amount of FOS that can be produced using 100 ml FTase is 400 ml whereas using 600 ml the amount of FOS that can be produced is 2.4 L

1. The process for obtaining Fructooligosaccharide (FOS), said process comprising the steps of:
(a) growing the culture in a medium at pH in the range of 5 to 6 and temperature in the range of 25 to 30° C. under stirring condition to obtain an inoculum,
(b) transferring predetermined concentration of the inoculum to a medium under fermentation conditions to obtain Fructosyl Transferase (Ftase),
(c) incubating the Ftase with a substrate in the range of 400 to 800 g/l at pH in the range of 5 to 5.5 for 18 to 24 hrs at a temperature range of 50 to 55° C., and
(d) optionally along with additives to improve quality of FOS.

2. The process as claimed in claim 1, wherein in step (a) the medium consists of sucrose in the range of 0.8 to 1.5% and yeast extract in the range of 0.1 to 0.5%.

3. The process as claimed in claim 1, wherein stirring in step (a) is done at 200 to 250 rpm for 24 to 48 hr.

4. The process as claimed in claim 1, wherein the culture used in step (a) is selected from group consisting of Aspergillus oryzae and Aspergillus pullulans, capable of producing FTase.

5. The process as claimed in claim 1, wherein the inoculum used is developed from 5 to 8 days old slant culture.

6. The process as claimed in claim 1, wherein the FTase is prepared by fermentation process selected from the group consisting of submerged fermentation process and solid state submerged process.

7. The process as claimed in claim 1, wherein the predetermined concentration of the inoculum varies in the range of 10 to 25% (v/v) for submerged fermentation and in the range of 10 to 25% (v/w) for solid state fermentation.

8. The process as claimed in claim 6, wherein the submerged fermentation medium consists of sucrose in the range of 10-12%, yeast extract in the range of 0.7-0.9%, MgSO₄.7H₂O in the range of 0.02-0.04%, NaNO₃ in the range of 1-3%, K₂HPO₄ in the range of 0.3-0.5%, K₂HPO₄ in the range of 0.8-1.0%, NaCl in the range of 0.5-0.7% and NH₄Cl in the range of 0.9-1.2% and incubated for 48 to 120 hr at a temperature ranging from 25-30° C. followed by discarding the pellets after filtering the culture broth to obtain Fructosyl Transferase (Ftase).

9. The process as claimed in claim 6, wherein the solid state fermentation medium consists of 10 to 12 gm of rice bran moistened with 10 to 12 ml water and incubated for 48 to 120 hr at a temperature ranging from 25-30° C. followed by extraction of moldy bran with water and filtering the same to obtain Fructosyl Transferase (Ftase).

10. The process as claimed in claim 1, wherein the FTase is incubated with the substrate selected from group consisting of sucrose, jaggery optionally along with stevia extract as an additive to improve the FOS sweetness.

11. The process as claimed in claim 10, wherein stevia extract is in the range of about 0.5 to 4%.

12. The process as claimed in claim 11, wherein the stevia extract is about 1%.

13. The process as claimed in claim 10, wherein the increase in sweetness of FOS is about 40%.

14. The process as claimed in claim 11, wherein the increase in sweetness of FOS is about 36%.

15. The process as claimed in claim 1, wherein the FOS contains kestose and nystose with functional properties namely non-cariogenicity and prebiotic property.

16. The process as claimed in claim 1, wherein FOS improves mineral absorption, reduces the total cholesterol and triglyceride levels in the body.

17. The process as claimed in claim 1, wherein 2.5 to 20% of FOS in diet improves the calcium absorption.

18. The process as claimed in claim 1, wherein 5 to 10% of FOS in diet improves the magnesium absorption.

19. The process as claimed in claim 1, wherein up to 10% of FOS in diet improves the copper absorption.

20. The process as claimed in claim 1, wherein 8 gm of FOS powder dose per day for weeks in the range of 5 to 5 reduces the cholesterol and triglycerides levels.

21. The process as claimed in claim 1, wherein FOS powder is obtained by spray drying of FOS at an inlet temperature ranging from 130 to 140° C., outlet temperature ranging from 90 to 95° C. and at a flow rate of 60 to 70 ml/min.

22. The process as claimed in claims 1 and 21, wherein the FOS additives are selected from the group consisting of maltodextrin ranging up to 15% and anti-caking agents namely tri-calcium phosphate ranging up to 2% during either before or after spray drying.

23. The process as claimed in claim 21, wherein FOS powder has dry matter content in the range of 98.6 to 98.8%, ash content in the range of 0.4 to 1.0% with solubility in the range of 95 to 96% in cold water and 100% in hot water.

24. The process as claimed in claim 21, wherein the additives improve the storage stability of the FOS powder and reduces the heat sensitively of FOS powder.

25. The process as claimed in claim 21, wherein the yield of FOS powder varies in the range of 50 to 96.5%.

26. The process as claimed in claims 1 and 4, wherein the culture is recycled for production of FOS.

27. The process as claimed in claim 25, wherein the culture is recycled at least 6 times for production of FOS.
